(19) United States
(12) Patent Application Publication
(10) Pub. No.: US 2010/0149112 A1
(43) Pub. Date: Jun. 17, 2010

(54) OSD CONTROL SYSTEM AND OSD CONTROL METHOD FOR CONTROLLING DISPLAY PANEL PROPERTIES ACCORDING TO SENSED TOUCH MOVEMENTS

(75) Inventor: Chih-Yi Lin, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX MEDIA SOLUTIONS, INC., Tainan County (TW)

(21) Appl. No.: 12/334,609

(22) Filed: Dec. 15, 2008

(51) Int. Cl. G06F 3/041; G08B 21/00

(52) U.S. Cl. 345/173; 340/665

(57) ABSTRACT

An OSD control system is provided and includes a display device. The display device includes a panel for displaying image data, a touch pad disposed around the panel, a display controller and a touch sensor controller. The touch pad includes touchable keys for sensing touch movements thereon and transferring interrupt signals upon sensing the touch movements. The display controller receives key status signals and controls display properties of the panel according to the key status signals. The touch sensor controller receives the interrupt signals, recognizes types and corresponding positions of the touch movements in response to the interrupt signals, and generates the key status signals according to the type and the positions of the touch movements.

### BACKGROUND OF THE INVENTION

1. Field of the Invention

The invention relates to an on screen display (OSD) control system, and more particularly to an OSD control system with further reduced control area.

2. Description of the Related Art

Liquid Crystal Displays (LCDs) have become a widely used display device in the modern world due to its fast response time, light weight, slim profile, high luminance, low power consumption and highly enlargeable display area . . . etc. For example, the LCD TV and the LCD monitor for a desktop computer have already been widely adopted along with the advancements in LCD display technology.

LCDs, being a kind of Flat Panel Display (FPD), is made up of a plurality of color or monochrome pixels arrayed in front of a light source or reflector. In forming an LCD device, a liquid crystal is inserted between two glass substrates, wherein the first substrate has a color filter, and the second substrate has transistors in it. As current passes through the transistors, an electric field is introduced and the liquid crystals are deflected. The rotation of the polarization of the incident light changes the direction of the incident light as it passes through the liquid crystal layer, and this light will then pass through the filter which filters out the light with different polarizations. By controlling the voltage applied across the liquid crystal layer in each pixel, light can be allowed to pass through in varying amounts, correspondingly illuminating the pixel.

Since volume is one of the reasons for the popularity of the LCD panel, a novel OSD control system with further reduced control area is highly required.

### BRIEF SUMMARY OF THE INVENTION

OSD control systems and methods for controlling a plurality of display properties of a panel according to a plurality of sensed touch movements on a touch pad are provided. An exemplary embodiment of an OSD control system is provided and includes a display device. The display device includes a panel for displaying image data, a touch pad disposed around the panel, a display controller and a touch sensor controller. The touch pad includes touchable keys for sensing touch movements thereon and transferring interrupt signals upon sensing the touch movements. The display controller receives key status signals and controls a plurality of display properties of the panel according to the key status signals. The touch sensor controller receives the interrupt signals, recognizes types and corresponding positions of the touch movements in response to the interrupt signals, and generates the key status signals according to the type and the positions of the touch movements.

Another exemplary embodiment provides an OSD control method for controlling a plurality of display properties of a panel according to a plurality of sensed touch movements on a touch pad, wherein the touch pad is disposed around the panel and provides a plurality of touchable keys for sensing the touch movements thereon, and wherein the panel and the touch pad are configured as a display device. The OSD control method comprises: detecting whether at least one of the touchable keys has been touched; recognizing a type and a corresponding position of the touch movement when the touchable key has been touched; determining a process for adjusting the display properties according to the recognized position and the recognized type of the touch movement; and executing the process for adjusting the display properties.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A shows an OSD control system according to an embodiment of the invention;

FIG. 1B shows an OSD control system according to another embodiment of the invention;

FIG. 2 shows an OSD control system according to another embodiment of the invention;

FIG. 3 shows a block diagram of the display device in the OSD control system according to the embodiment of the invention; and

FIG. 4 shows a flow chart of an OSD control method for controlling a plurality of display properties of a panel according to a plurality of sensed touch movements on a touch pad according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A monitor usually includes a control area with several built in buttons which provide users the capability of adjusting some display properties of the monitor by operating (or pressing) the buttons. The display properties may include luminance, contrast, display color, or display position adjustments for displaying the image data on the monitor. However, the built in buttons result in non-utilized display areas, thus, causing space usage inefficiencies. Additionally, the built in buttons are easily damaged or worn out over a period of time of usage. Thus, a novel OSD control system with further reduced non-utilized display areas and volume thereof is provided.

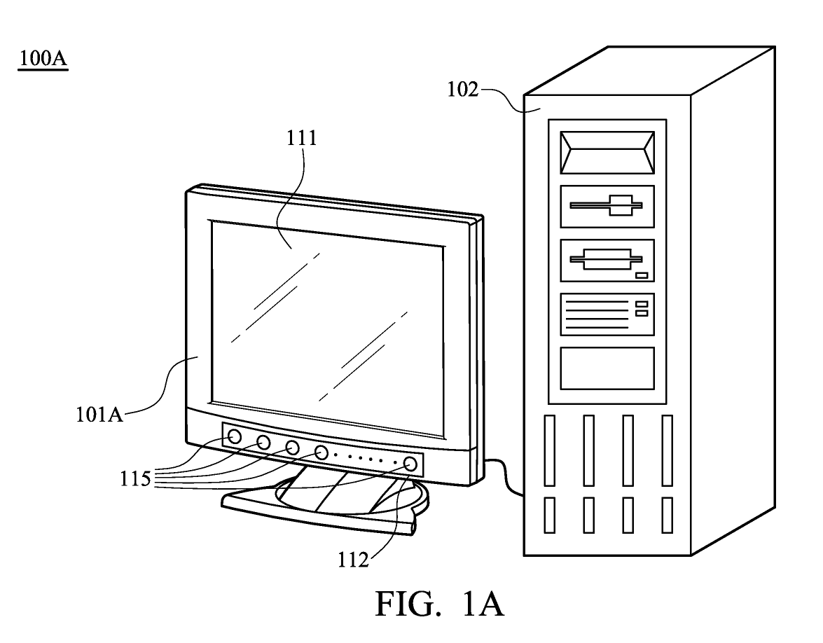

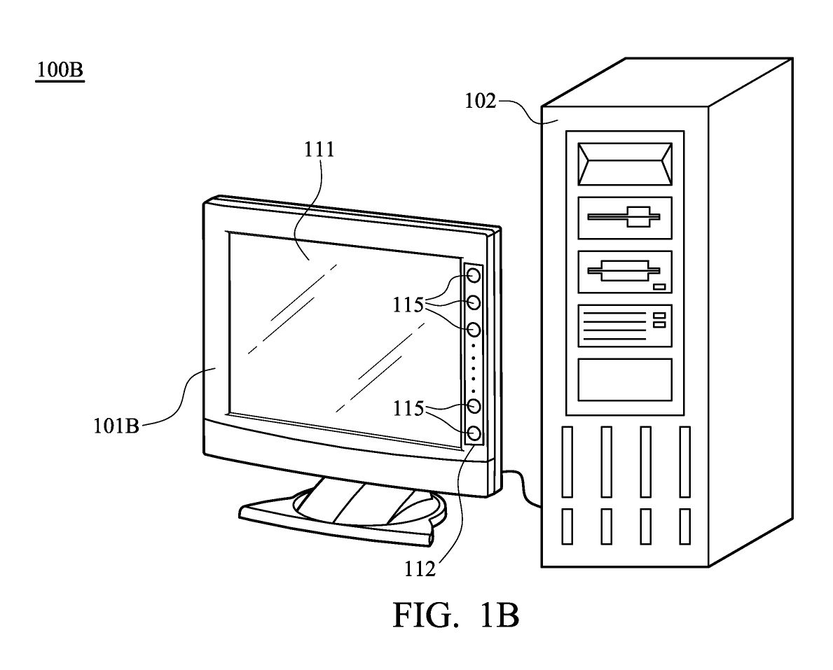

FIG. 1A shows an OSD control system 100A according to an embodiment of the invention. The OSD control system 100A comprises a host 102 and a display device 101A. The host 102 provides image data to be displayed. The display device 101A comprises a panel 111 for displaying the image data, a touch pad 112 disposed around the panel and with a plurality of touchable keys 115, a touch sensor controller built inside of the display device 101A for controlling the touch pad 112, and a display controller built inside of the display device 101A for controlling the panel 111 and the touch sensor controller. According to the embodiment of the invention, the display device may be a desktop monitor disposed external to the host 102 and detachably connected to the host 102 for displaying the image data. As shown in FIG. 1A, the touch pad 112 may be disposed below the panel 111. However, it is to be noted that the touch pad 112 may be disposed anywhere around the panel 111 and the invention should not be limited thereto. As an example, FIG. 1B shows an OSD control system 100B according to another embodiment of the invention. As shown in FIG. 1B, the touch pad 112 is disposed on the right side of the panel 111.

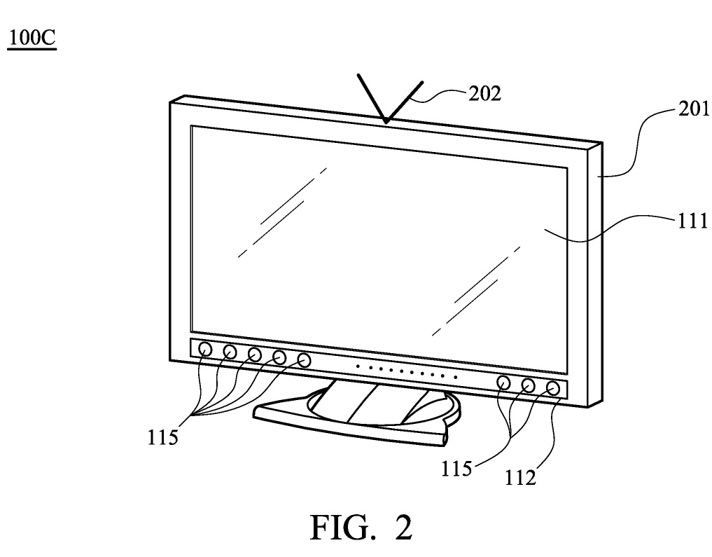

FIG. 2 shows another OSD control system 100C according to another embodiment of the invention. The OSD control system 100C comprises a display device 201. According to the embodiment of the invention, the display device 201 may be a television set, as an example, a LCD TV. The display device 201 comprises a receiver built inside or outside of the display device 201 for receiving display data, such as TV programs, broadcast over the air via antenna 202 or from a cable, decoding the display data, and accordingly providing the display data as the image data to be displayed. The display device 201 further comprises a panel 111 for displaying the image data, a touch pad 112 disposed around the panel and with a plurality of touchable keys 115, a touch sensor controller built inside of the display device 201 for controlling the touch pad 112, and a display controller built inside of the display device 201 for controlling the panel 111 and the touch sensor controller. It is to be noted that the touch pad 112 may be disposed anywhere around the panel 111 and the invention should not be limited thereto. As an example, the touch pad 112 is disposed on the right or left side of the panel 111.

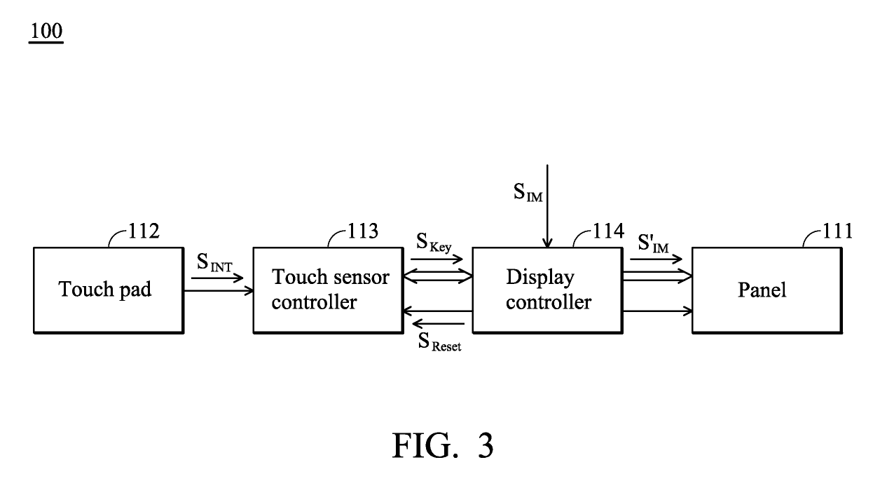

FIG. 3 shows a block diagram of the display device in the OSD control system according to the embodiment of the invention. The touchable keys (such as touchable keys 115 shown in FIG. 1A, FIG. 1B or FIG. 2) of the touch pad 112 senses touch movements thereon and the touch pad 112 transfers interrupt signals S_{INT} upon sensing the touch movements. The touch sensor controller 113 is connected to the display controller 114 and the touch pad 112, receives the interrupt signals S_{INT} from the touch pad 112, recognizes types of the touch movements and corresponding positions of the touch movements in response to the interrupt signals S_{INT}, and generates the key status signals S_{Key} according to the type and the positions of the touch movements. The display controller 114 receives the image data S_{IM} from the host 102 and transmits the image data S′_{IM} to the panel 111 according to the image data S_{IM}. The display controller 114 further receives key status signals S_{Key} from the touch sensor controller 113, and controls a plurality of display properties of the panel 111 according to the key status signals S_{Key}. The display controller 114 may further reset the touch sensor controller 113 by sending a reset signal S_{Reset} to the touch sensor controller 113. It is noted that the display controller 114 may also directly access the key status signals S_{Key} stored in the touch sensor controller 113 and the invention should not be limited thereto.

According to the embodiment of the invention, the touchable keys (e.g. 115) accompanying the On Screen Display (OSD) are capable of providing functionalities for users to adjust the display properties of the panel as previously described. The touch pad may further comprise a corresponding light emitting diode (LED) unit (not shown) thereon for each touchable key for emitting light according to the sensed touch movements. As an example, when one of the touchable key senses the touch movement, the corresponding LED unit is turned on to emit light. As another example, when the type of the touch movement is recognized as a slide movement, such as adjusting the contrast by sliding a contrast bar of the OSD, the corresponding LED unit is turned off due to detection of the slide movement.

According to an embodiment of the invention, since the key status signals S_{Key} may include information about the type and the corresponding position of the touch movement, the display controller 114 may further generate an OSD image layer in order to provide a visible image that represents the adjustment operations of the display properties, for users to easily perform the process of adjusting the display properties. For example, the OSD image layer may display a drawing of the contrast bar, according to the key status signals S_{Key}. The display controller 114 may further merge the OSD image layer with the image data S_{IM} received from the host 102, and transmit the merged image data S′_{IM} to the panel 111 for display. Upon receiving the key status signals S_{Key} indicating the operations of the users, the display controller 114 may further accordingly adjust the display properties of the panel 111. According to an embodiment of the invention, the panel 111 may be a Liquid Crystal Display (LCD) panel.

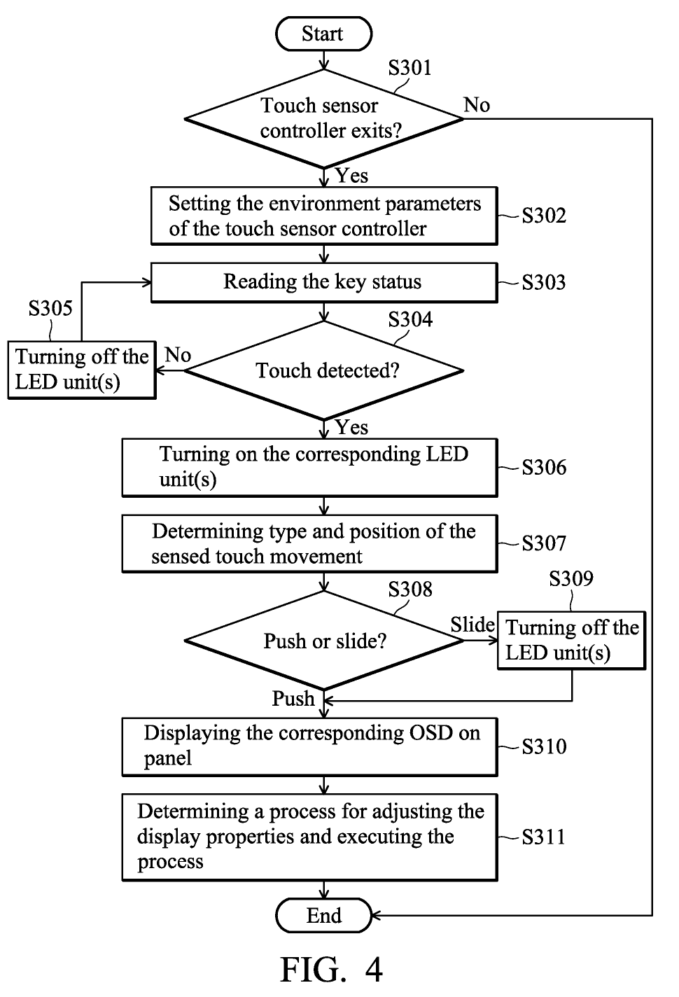

FIG. 4 shows a flow chart of an OSD control method for controlling a plurality of display properties of a panel according to a plurality of sensed touch movements on a touch pad according to an embodiment of the invention. In the beginning, the display controller (e.g. 114) determines whether the touch sensor controller (e.g. 113) has exited in the display device (Step S301). The determination may be implemented by checking the chip ID of the touch sensor controller. When the touch sensor controller is determined to have exited in the display device, the display controller sets the environment parameters of the touch sensor controller (Step S302). Next, the display controller reads the key status of the touch pad (Step S303). Next, the display controller determines whether touch movement is sensed by the touchable keys according to the key status (Step S304). When there is no touch movement being sensed, the display controller directs the touch sensor controller to turn off the LED unit(s) (Step S305) and keeps on detecting for touch movement. Alternatively, when there is sensed touch movement, the display controller directs the touch sensor controller to turn on the corresponding LED unit(s) (Step S306) to indicate that the touch movement has been detected. Next, the display controller determines the type and the position of the sensed touch movement according to the key status signals (Step S307). Next, the display controller determines whether the touch movement is a push or a slide movement (Step S308). When a slide movement is determined, the corresponding LED unit is turned off to represent the detection of the slide movement (Step S309). Next, the display controller provides the corresponding OSD image layer according to the type and position of the movement and displaying OSD image layer on the panel (Step S310). As previously described, the display controller provides the OSD image layer as a visible image representing the adjustment operation of the display properties for users to easily perform the process of adjusting the display properties on the panel. Finally, the display controller determines a process for adjusting the display properties according to the operations of the user sensed by the touch pad, and executes the process for adjusting the display properties (Step S311).

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An on screen display (OSD) control system, comprising:
a display device, comprising:
a panel for displaying image data;
a touch pad disposed around the panel and comprising a plurality of touchable keys for sensing a plurality of touch movements thereon and transferring a plurality of interrupt signals upon sensing the touch movements;
a display controller receiving the image data and transmitting the image data to the panel, receiving a plurality of key status signals, and controlling a plurality of display properties of the panel according to the key status signals; and
a touch sensor controller coupled to the display controller and the touch pad, receiving the interrupt signals, recognizing types of the touch movements and corresponding positions of the touch movements in response to the interrupt signals, and generating the key status signals according to the type and the positions of the touch movements.

2. The OSD control system as claimed in claim 1, wherein the touch pad further comprises a corresponding light emitting diode (LED) unit thereon for each touchable key for emitting light according to the sensed touch movements.

3. The OSD control system as claimed in claim 2, wherein when the touchable key senses the touch movement, the corresponding LED unit is turned on to emit light.

4. The OSD control system as claimed in claim 2, wherein when the type of the touch movement is recognized as a slide movement, the corresponding LED unit is turned off.

5. The OSD control system as claimed in claim 1, wherein the display properties comprise luminance, contrast, display color, and display position properties for displaying the image data.

6. The OSD control system as claimed in claim 1, wherein the display controller further adjusts the display properties of the panel according to the received key status signals.

7. The OSD control system as claimed in claim 1, wherein the display controller further generates an OSD image layer according to the key status signals, merges the OSD image layer with the image data, and transmits the merged image data to the panel for display.

8. The OSD control system as claimed in claim 1, wherein the panel is a Liquid Crystal Display (LCD) panel.

9. The OSD control system as claimed in claim 1, further comprising a host for providing the image data to the display device, and wherein the display device is a desktop monitor disposed external to the host and detachably connected to the host.

10. The OSD control system as claimed in claim 1, wherein the display device is a television set and further comprises a receiver receiving display data and accordingly providing the image data to the display controller.

11. An on screen display (OSD) control method for controlling a plurality of display properties of a panel according to a plurality of sensed touch movements on a touch pad, wherein the touch pad is disposed around the panel and provides a plurality of touchable keys for sensing the touch movements thereon, and wherein the panel and the touch pad are configured as a display device, comprising:
detecting whether at least one of the touchable keys has been touched;
recognizing a type and a corresponding position of the touch movement when the touchable key has been touched;
determining a process for adjusting the display properties according to the recognized position and the recognized type of the touch movement; and
executing the process for adjusting the display properties.

12. The OSD control method as claimed in claim 11, wherein the panel is a Liquid Crystal Display (LCD) panel.

13. The OSD control method as claimed in claim 11, wherein the display device is a desktop monitor is detachably connected to a host to provide image data to be displayed on the panel.

14. The OSD control method as claimed in claim 11, wherein the display device is a television set and further comprises a receiver receiving display data and accordingly providing image data to be displayed on the panel.

15. The OSD control method as claimed in claim 13, further comprising:
providing an On Screen Display (OSD) image layer to be displayed on the panel according to the recognized position and the recognized type of the touch movement;
merging the OSD image layer with the image data; and
displaying the merged image data on the panel.

16. The OSD control method as claimed in claim 11, wherein the touch pad further comprises a corresponding light emitting diode (LED) unit thereon for each touchable key, and the method further comprises turning on the corresponding LED unit to emit light when the touchable key is touched.

17. The OSD control method as claimed in claim 16, wherein when the touch movement is recognized as a slide movement, the method further comprises turning off the corresponding LED unit.

18. The OSD control method as claimed in claim 13, wherein the display properties comprise luminance, contrast, display color, and display position properties for displaying the image data.
